(19) United States
(12) Patent Application Publication
(10) Pub. No.: US 2006/0243334 A1
(43) Pub. Date: Nov. 2, 2006

(54) Gas valve

(75) Inventors: Detlef Brochhaus, Osnabruck (DE); Peter Bungard, Melle (DE)

Correspondence Address: Jay F. Moldovanyi, Esq.;Fay, Sharpe, Fagan, Minnich & McKee, LLP, Seventh Floor, 1100 Superior Avenue, Cleveland, OH, 44114-2579, US

(73) Assignee: G. Kromschroder AG

(21) Appl. No.: 11/410,721

(22) Filed: Apr. 25, 2006

(30) Foreign Application Priority Data
Apr. 28, 2005 (DE) 10 2005 020 206.3

(51) Int. Cl. F16K 11/04

(52) U.S. Cl. 137/625.33

(57) ABSTRACT

A gas valve is disclosed with
a housing (1), which has a gas pathway consisting of an inlet branch (2) and an outlet branch (3) and an insertion opening (4), which is accessible from the exterior and intersects the gas pathway, wherein the housing (1) affords two axially spaced housing sealing surfaces (6) extending around the insertion opening (4) and wherein the area of the insertion opening (4) between the two housing sealing surfaces (6) is laterally closed with the exception of the mouth of one of the two branches (2, 3) of the gas pathway whilst the other branch on the other side of this area is in communication with the insertion opening (4), and
a cartridge (5), which is inserted into the insertion opening (4) and has two cartridge sealing surfaces (8) complementary to the housing sealing surfaces (6) and an interior, which is closed at at least one end, whereby the interior is laterally closed between the two cartridge sealing surfaces (8) and on the other side of at least one of the cartridge sealing surfaces (8) and whereby at least one axially movable valve body (9, 11) cooperates in the interior space with an associated valve seat (10, 12), which is preferably associated with one of the cartridge sealing surfaces (8).

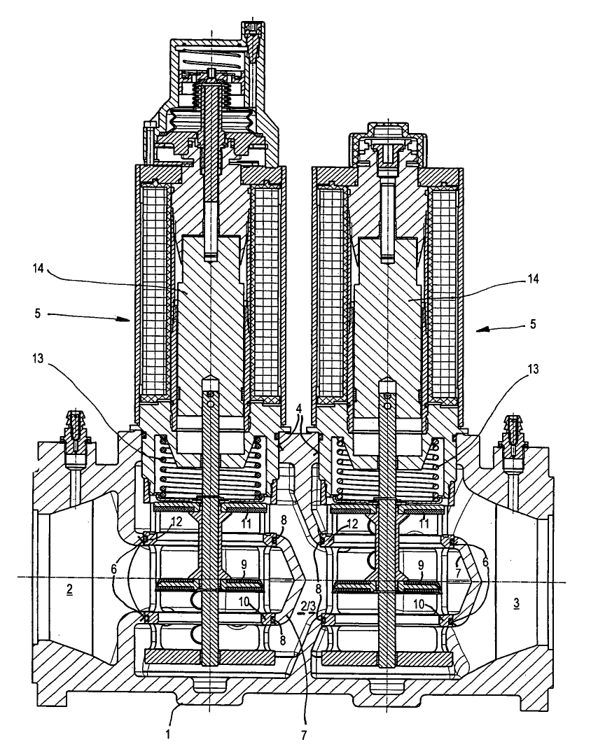

The invention relates to a gas valve.

It is the object of the invention to provide a gas valve, which is variable in its function and is favourable as regards manufacturing technology.

To this end, the gas valve in accordance with the invention is provided with
a housing, which has a gas pathway consisting of an inlet branch and an outlet branch and at least one insertion opening, which is accessible from the exterior and intersects the gas pathway, wherein the housing affords two axially spaced housing sealing surfaces extending around the insertion opening and wherein the area of the insertion opening between the two housing sealing surfaces is laterally closed with the exception of the mouth of one of the two branches of the gas pathway whilst the other branch on the other side of this area is in communication with the insertion opening, and
a cartridge, which is inserted into the insertion opening and has two cartridge sealing surfaces complementary to the housing sealing surfaces and an interior, which is closed at at least one end, the interior being laterally open between the two cartridge sealing surfaces and on the other side of at least one of the cartridge sealing surfaces, at least one axially movable valve body cooperating in the interior space with an associated valve seat, which is preferably associated with one of the cartridge sealing surfaces.

The gas enters the housing on the inlet side and flows into the internal cavity of the cartridge, either into the space between the two cartridge sealing surfaces or into the space on the other side of at least one of the two cartridge sealing surfaces. If the valve body has been lifted away from its valve seat, the gas can then leave the housing on the outlet side. The gas flow through the gas pathway defined by the housing can thus be either in one direction or in the other direction.

The substantial advantage of the invention resides in the fact that the safety function associated with the housing is decoupled from the valve function, the latter being associated with the cartridge.

The result of this is the possibility to use one and the same housing in a multifunctional manner, namely by using different cartridges which are constructed in the form of a shut-off valve, a throttle valve, a controller or the like.

The housing also needs only coarse mechanical machining whilst the fine mechanical machining is limited to the cartridge. This applies, in particular, if, as is further proposed, at least one respective sealing ring is disposed between the complementary sealing surfaces, the sealing surfaces preferably being disposed parallel to one another.

The difficult working areas in the manufacturing process can thus be split up, whereby lower requirements may be placed on the fabrication precision of the housing than on the cartridge.

The housing of the gas valve is preferably cast from metal, whereby one can tolerate potential porosity of the casting since the sealing function is decoupled from the housing and is associated with the cartridge.

It should also be mentioned that maintenance of the device and, if necessary, replacement in situ on the installation is facilitated and that despatch and transport costs can be reduced.

The angle at which the insertion opening intersects the gas pathway is basically not critical. However, there are reasons relating to manufacturing technology which suggest that an angle of preferably 90° be selected.

A separate component inserted into the housing can serve to close the area of the insertion opening between the two housing sealing surfaces with the exception of the mouth of one of the two branches of the gas pathway. It is, however, on the other hand more advantageous to achieve this closure by means of a housing inner wall, particularly if the housing is cast.

The valve body can be movable on the other side of the space between the two cartridge sealing surfaces. It is, however, more preferably movable within this space.

A further advantageous feature resides in that the valve body is acted on by a closure spring and is connected to an electromagnetic actuator, which is integrated into the cartridge. The cartridge thus constitutes a separate assembly which alone fulfils the entire valve function and need merely be inserted into the housing and connected to it.

In an important further feature of the invention, it is proposed that the internal cavity in the cartridge on the other side of both cartridge sealing surfaces is laterally open and that connected to the first valve body there is a second valve body, which cooperates with an associated valve seat, which is preferably associated with the other cartridge sealing surface. There is thus a double-seat valve, the advantage of which resides in its small size. One of the valve bodies operates within the space between the two cartridge sealing surfaces whilst the other valve body moves outside this space. The internal cavity of the cartridge is open on both sides on the other side of the space between the two cartridge sealing surfaces.

In accordance with a further advantageous feature, the housing has two insertion openings with associated cartridges, which are arranged in series in the gas pathway.

The invention will be explained in more detail below by way of a preferred exemplary embodiment in conjunction with the accompanying drawing. The drawing is an axial sectional view of a gas valve in accordance with the invention.

The illustrated gas valve has a cast housing 1, which defines a gas pathway extending through the housing. This pathway consists of an inlet branch 2 and an outlet branch 3. Flow through the gas valve in the present case is thus from the left to the right. The flow direction can, however, readily be reversed.

The housing also has two insertion openings 4, which are accessible from above and intersect the gas pathway at right angles. They serve to accommodate respective cartridges 5, which take over the actual function of the valve. At each insertion opening 4, the housing 1 affords two axially spaced housing sealing surfaces 6, which are parallel to one another and extend around the associated insertion opening 4. The area of each insertion opening 4 between the housing sealing surfaces 6 is laterally closed by a housing inner wall 7, whereby only the mouth of the associated branch of the gas pathway remains open. The other branch of the gas pathway is in communication on both sides with the associated insertion opening 4 on the other side of the area situated between the two housing sealing surfaces 6.

Each cartridge 5 has two cartridge sealing surfaces 8 complementary to the housing sealing surfaces 6, a sealing ring being inserted between the respective complementary sealing surfaces. The interior of each cartridge 5 is closed at the top and the bottom but is laterally open, not only in the area between the cartridge sealing surfaces 8 but also on both sides on the other side of this area. It thus defines, in an advantageous manner, a cage-like structure. Movable in the space between the cartridge sealing surfaces 8 is a first valve body 9, which cooperates with a valve seat 10, which is associated with the lower cartridge sealing surface 8. Connected to the first valve body 9 is a second valve body 11, which moves above the space between the cartridge sealing surfaces 8 and cooperates with a valve seat 12, which is associated with the upper cartridge sealing surface 8. Each cartridge 5 thus defines a double-seat valve whose size is minimised. The two valve bodies 9 and 11 are both acted on by a closing spring 13 and are connected to a respective electromagnetic actuator 14, which is integrated into the associated cartridge 5.

The gas flows into the left-hand cartridge 5 and reaches the space between the cartridge sealing surfaces 8. When the valve bodies 9 and 11 are open, it flows through the valve seats 10 and 12 and reaches the right-hand cartridge 5, again in the space between the cartridge sealing surfaces 8. After passing the valve seats 10 and 12, it leaves the valve via the outlet branch 3 of the gas pathway.

Modifications are of course possible within the context of the invention with respect to the illustrated embodiment. Thus the housing can have only a single insertion opening, which can also intersect the gas pathway at an oblique angle. Furthermore, each cartridge can operate with a single valve body and a single associated valve seat. It is thus sufficient to open the cartridge laterally only on the other side of one of the cartridge sealing surfaces. The single valve body can operate within the space between the cartridge sealing surfaces or to one side on the other side of this space. The cartridge sealing surface not associated with the single valve body then simultaneously constitutes the axial closure of the interior of the cartridge. If, for instance, only the valve body 9 is used, the interior of the cartridge 5 can be open downwardly. The valves need not necessarily be associated with the sealing surfaces. One can also deviate from the cage-like structure of the cartridge.

1. A gas valve including:
a housing, which has a gas pathway consisting of an inlet branch and an outlet branch and an insertion opening, which is accessible from the exterior and intersects the gas pathway, wherein the housing affords two axially spaced housing sealing surfaces extending around the insertion opening and wherein the area of the insertion opening between the two housing sealing surfaces is laterally closed with the exception of the mouth of one of the two branches of the gas pathway whilst the other branch on the other side of this area is in communication with the insertion opening, and
a cartridge, which is inserted into the insertion opening and has two cartridge sealing surfaces complementary to the housing sealing surfaces and an interior, which is closed at at least one end, the interior being laterally open between the two cartridge sealing surfaces and on the other side of at least one of the cartridge sealing surfaces, at least one axially movable valve body cooperating in the interior space with an associated valve seat, which is preferably associated with one of the cartridge sealing surfaces.

2. A gas valve as claimed in claim 1, wherein at least one respective sealing ring is disposed between the complementary sealing surfaces.

3. A gas valve as claimed in claim 1 wherein the sealing surfaces are disposed parallel to one another.

4. A gas valve as claimed in claim 1 wherein the insertion opening intersects the gas pathway.

5. A gas valve as claimed in claim 1 further comprising a housing inner wall, which closes the area of the insertion opening between the two housing sealing surfaces with the exception of the mouth of one of the two branches of the gas pathway.

6. A gas valve as claimed in claim 1 wherein the valve body is movable in the space between the two cartridge sealing surfaces.

7. A gas valve as claimed in claim 1 wherein the valve body is acted on by a closing spring and is connected to an electromagnetic actuator, which is integrated into the cartridge.

8. A gas valve as claimed in claim 1 wherein the interior space of the cartridge on the other side of the two cartridge sealing surfaces is laterally open and that connected to the first valve body there is a second valve body, which cooperates with an associated valve seat, which is preferably associated with the other cartridge sealing surface.

9. A gas valve as claimed in claim 1 wherein the housing has includes two insertion openings with associated cartridges, which are arranged in series in the gas pathway.

10. A gas valve including:
a housing, including a gas pathway comprising an inlet branch, an outlet branch and an insertion opening, which is accessible from an exterior of the housing and intersects the gas pathway, wherein the housing affords two axially spaced housing sealing surfaces extending around the insertion opening and wherein an area of the insertion opening between the two housing sealing surfaces is laterally closed with the exception of a mouth of one of the two branches of the gas pathway while the other branch on the other side of this area is in communication with the insertion opening, and
a cartridge, which is inserted into the insertion opening and includes two cartridge sealing surfaces complementary to the housing sealing surfaces, the cartridge further including an interior, which is closed at at least one end, an interior thereof being laterally open between the two cartridge sealing surfaces and on the other side of at least one of the cartridge sealing surfaces, and at least one axially movable valve body cooperating in the interior space with an associated valve seat, the valve seat being associated with one of the cartridge sealing surfaces.

11. A gas valve as claimed in claim 10, wherein at least one respective sealing ring is disposed between the complementary sealing surfaces.

12. A gas valve as claimed in claim 10, wherein the sealing surfaces are disposed parallel to one another.

13. A gas valve as claimed in claim 10 wherein the insertion opening intersects the gas pathway.

14. A gas valve as claimed in claim 10 further comprising a housing inner wall, which closes the area of the insertion opening between the two housing sealing surfaces with the exception of the mouth of one of the two branches of the gas pathway.

15. A gas valve as claimed in claim 10 wherein the valve body is movable in the space between the two cartridge sealing surfaces.

16. A gas valve as claimed in claim 10 wherein the valve body is acted on by a closing spring and is connected to an electromagnetic actuator, which is integrated into the cartridge.

17. A gas valve as claimed in claim 10 wherein the interior space of the cartridge on the other side of the two cartridge sealing surfaces is laterally open and that connected to the first valve body there is a second valve body, which cooperates with an associated valve seat, which is preferably associated with the other cartridge sealing surface.

19. A gas valve as claimed in claim 10 wherein the housing includes two insertion openings with associated cartridges, which are arranged in series in the gas pathway.
